(19) United States
(12) Patent Application Publication
(10) Pub. No.: US 2026/0084766 A1
(43) Pub. Date: Mar. 26, 2026

(54) Track Tension Monitoring System

(71) Applicant: Calerpillar Inc., Peoria, IL (US)

(72) Inventor: Sean David Lawson, East Peoria, IL (US)

(73) Assignee: Caterpillar Inc., Peoria, IL (US)

(21) Appl. No.: 18/891,537

(22) Filed: Sep. 20, 2024

(51) Int. Cl. B62D 55/30; B62D 55/15; B62D 55/32

(52) U.S. Cl. CPC B62D 55/305; B62D 55/15; B62D 55/32

(57) ABSTRACT

A tension monitoring system for a track-type machine, including a track adjuster configured to be attached to a front idler and a rear idler of a roller frame of a track-type drivetrain, and move the front idler relative to the roller frame; a sensor mounted to the front idler configured to measure a position of the front idler relative to the roller frame; and a controller connected to the sensor configured to receive a front idler position in response to a wear indicator of a service interval for the track-type machine, evaluate the front idler position reading compared to a predicted front idler position, calculate an adapted wear rate and an adjustment interval, and rewrite a predicted wear rate based on the adjustment interval.

### TECHNICAL FIELD

The present disclosure generally relates to work machines, and more particularly relates to tension monitoring systems in track type work machines.

### BACKGROUND

Mobile work machines may be used in the heavy industries such as mining, construction, and the like to transport materials and personnel. These work machines are often large in size, and require an operator, e.g., a driver, to manually operate the machine in order for the machine to perform its designated/intended operations.

Certain work machines, such as loaders, use implements to perform various tasks on a work site. These implements may be required to carry and transfer heavy loads, and as such, may utilize hydraulic systems to aid in operating mechanisms for the implements. These hydraulic systems are required to be robust in order to withstand the heavy loads, and failure of hydraulic components can often lead to treacherous results.

In off-road work machines, it may be desirable to use drivetrain configurations that use tracks rather than wheels. Tracked work machines present several advantages over wheeled counterparts. Tracked machines may offer smoother rides over uneven terrain, as the wide footprint of a track can absorb more energy than a tire can. Tracked machines may offer superior traction consistency, losing traction far less often. Tracked drivetrains are generally more robust than wheeled system, and can reduce downtime. As these work machines often operate in soft, wet, and uneven terrain, tracked drivetrains offer greater flexibility, and more consistent operation through various seasonal challenges.

Tracks of track-type machines, for example as in track-type tractors, being components contacting the ground, are susceptible to wear over the lifetime of the track-type tractor. The tracks of these systems are typically driven by a sprocket, and are tensioned by a front and a rear idler, with a number of rollers located between the idlers proximate a bottom surface of the track that comes in contact with the ground. As the service life of the track-type tractor furthers, the tension on the tracks may decrease, and the track may slack. Improper track tension can result in reduced undercarriage life, increased fuel consumption, and poor grading performance of the track-type tractor, among other issues.

In order to adjust track tension, track-type machines may be equipped with track adjustment mechanisms. These adjustment mechanisms may increase or decrease tension in the track by adjusting a distance between the front and rear idler. Ideally, this is accomplished by moving the front idler in a forward direction relative the roller frame. Track adjusters on track-type machines in general may be adjusted in this manner through mechanical adjustment. In order to verify a proper adjustment, workers often visually compare a level of slack in the track such that it is within an acceptable range.

In light of the aforementioned shortcomings, there remains a need for a track-type work machine to have a system that is capable of monitoring the track tension over the lifetime of the track by measuring a position of the front idler. There also remains a need for a monitoring system that can predict a front idler position at a given service life interval, and adjust a predicted track tension performance as a result of findings at the given service life interval.

### SUMMARY OF THE DISCLOSURE

In accordance with one aspect of the disclosure, a work machine may be provided. The work machine may comprise a frame, and an implement supported by the frame. The work machine may comprise a track-type drivetrain attached to the frame and configured to support the frame and provide motive power to the work machine, the track-type drivetrain including a roller frame, a sprocket, a rear idler, a front idler, a roller, and a track. The work machine may comprise a track adjuster mounted on the roller frame configured such that the front idler can be adjusted on the roller frame relative to the rear idler, a tension in the track modified therein. The work machine may comprise a controller configured to control operation of the work machine. The work machine may comprise a sensor mounted proximate the front idler to, the sensor configured to communicate with the controller to monitor a position of the front idler relative to the rear idler.

In accordance with another aspect of the disclosure, a tension monitoring system for a track-type machine may be provided. The tension monitoring system may comprise a track adjuster configured to be attached to a front idler and a rear idler of a roller frame of a track-type drivetrain, and move the front idler relative to the roller frame. The tension monitoring system may comprise a sensor mounted to the front idler configured to measure a position of the front idler relative to the roller frame. The tension monitoring system may comprise a controller connected to the sensor configured to receive a front idler position, distance travelled, and wear indicator signal, evaluate the front idler position reading compared to a predicted front idler position, calculate an adapted wear rate and an adjustment interval, and rewrite a predicted wear rate based on the adjustment interval.

In accordance with yet another aspect of the disclosure, method of monitoring track tension of a track-type work machine may be provided. The method may comprise providing a track-type drivetrain attached to a frame of a work machine, including a roller frame, a sprocket, a rear idler, a front idler, a roller, and a track, the roller frame including a track adjuster configured to space the front idler relative to the rear idler, thereby adjusting tension in the track. The method may comprise attaching a sensor to the front idler configured to measure a front idler position. The method may comprise connecting the sensor to a controller. The method may comprise programming a predicted wear rate on a memory of the controller, the predicted wear rate configured to provide a predicted idler position at a service interval of the track-type work machine based on an undercarriage life measurement. The method may comprise measuring the front idler position via the sensor, at the service interval. The method may comprise determining that the front idler position is different from the predicted idler position, the controller then calculating an adapted wear rate, calculating an adjustment interval, and rewriting the predicted wear rate based on the adjustment interval.

These and other aspects and features of the present disclosure will be more readily understood when read in conjunction with the accompanying drawings.

### BRIEF DESCRIPTION OF THE DRAWINGS

FIG. 1 is a perspective view of a work machine constructed in accordance with an embodiment of the present disclosure.

FIG. 2 is an enhanced view of a track-type drivetrain of the work machine of FIG. 1 constructed in accordance with an embodiment of the present disclosure.

FIG. 3 is a perspective view of a work machine on a level surface constructed in accordance with an embodiment of the present disclosure.

FIG. 4 is a perspective view of a work machine on a downhill surface constructed in accordance with an embodiment of the present disclosure.

FIG. 5 is a side view of a work machine constructed in accordance with an embodiment of the present disclosure.

FIG. 6 is an enhanced view of a track adjuster of a work machine constructed in accordance with an embodiment of the present disclosure.

FIG. 7 is a cross-section view of a track adjuster of a work machine constructed in accordance with an embodiment of the present disclosure.

FIG. 8 is a chart of a predicted wear curve of a track of a work machine constructed in accordance with an embodiment of the present disclosure.

FIG. 9 is a chart of an adjusted wear curve against a predicted wear curve of a track of a work machine constructed in accordance with an embodiment of the present disclosure.

FIG. 10 is a chart of an adjusted wear curve against a predicted wear curve of a track of a work machine constructed in accordance with an embodiment of the present disclosure.

FIG. 11 is a flowchart depicting a sample sequence of steps for monitoring track tension of a work machine, which may be practiced in accordance with the work machine of the present disclosure.

The figures depict one embodiment of the presented invention for purpose of illustration only. One skilled in the art will readily recognize form the following discussion that alternative embodiments of the structures and method illustrated herein may be employed without departing form the principles described herein.

### DETAILED DESCRIPTION

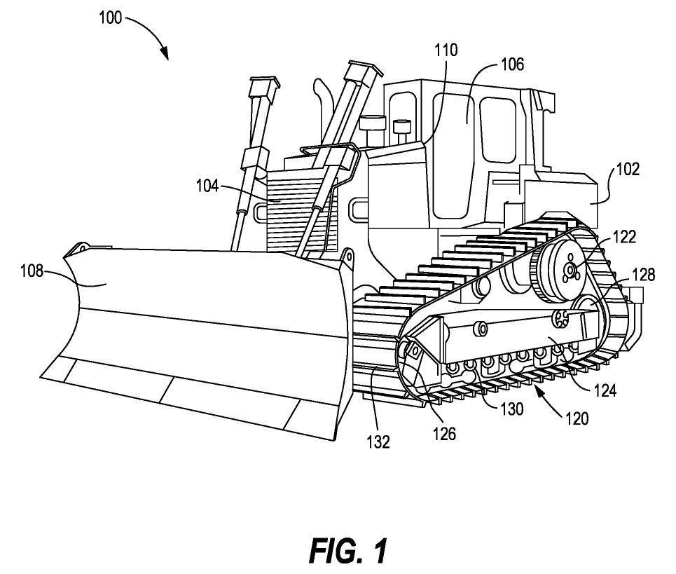

Referring now to the drawings, and with specific reference to FIG. 1, a work machine is depicted and generally referred to using reference numeral 100. The work machine 100 is exemplarily embodied in the form of a track-type tractor. While the work machine 100 is depicted as a track-type tractor, it should be noted that a type of machine used is merely exemplary and illustrative in nature. It will be acknowledged that the teachings of the present disclosure can be similarly applied to other types of work machines including but not limited to on and off highway trucks, excavators, loaders, mining vehicles, and other types of machines having track-type drivetrains known to persons skilled in the art.

Work machines, and specifically track-type tractors, may be used to lift, transport, and deposit material from one spot to another on rough terrain. The work machine 100 is supported by a frame 102. The work machine 100 may include a track-type drivetrain 120 attached to the frame 102, and powered by an engine 104 for providing motive power to the work machine 100.

The work machine 100 may also include an implement 108 to perform a work job. In the view of FIG. 1, since the work machine 100 is a track-type tractor, the implement 108 is exemplarily depicted as a bulldozer scraper, but with other machines the implement may be other types of work implements known to persons skilled in the art. The work machine 100 may also include an operator cabin 106 for an operator to control the operation of the work machine 100. The operator cabin 106 may include a controller 110 for the operator to use to direct the work machine 100.

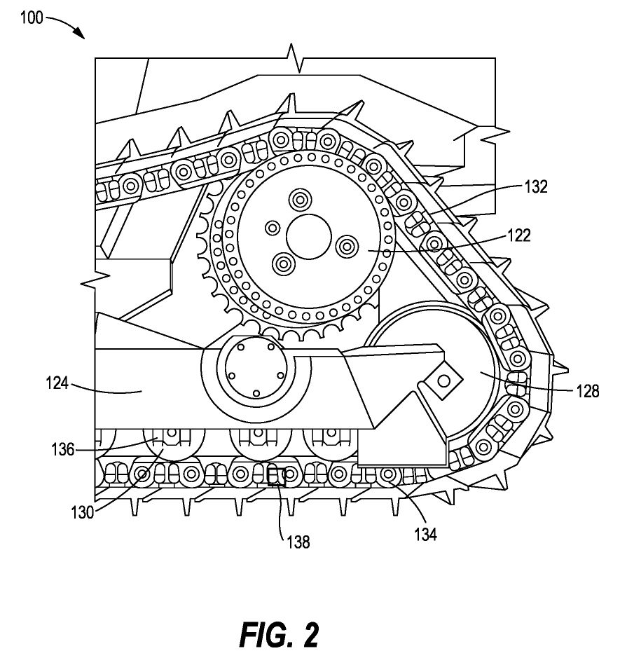

The track-type drivetrain 120 may include a sprocket 122, a roller frame 124, a front idler 126, a rear idler 128, a roller 130, and a track 132. The track 132 may encircle the track-type drivetrain 120 and may be driven by the sprocket 122, and be tensioned by placement of the front idler 126 and the rear idler 128. FIG. 2 shows a portion of the track-type drivetrain 120 in greater detail. The roller 130 may include a single roller, or a plurality of rollers as shown in FIGS. 1-2. The roller 130, the front idler 126, and the rear idler 128 are connected to the roller frame 124 through a number of connectors 136. The track 132 may comprise a plurality of sections, including a plurality of links 134. Each of the plurality of links 134 may include a wear sensor 138 embedded into the link. The wear sensor 138 may include wireless capabilities, such as Bluetooth connectivity, that permit the plurality of links 134 to communicate with the controller 110 and report a life percentage estimate.

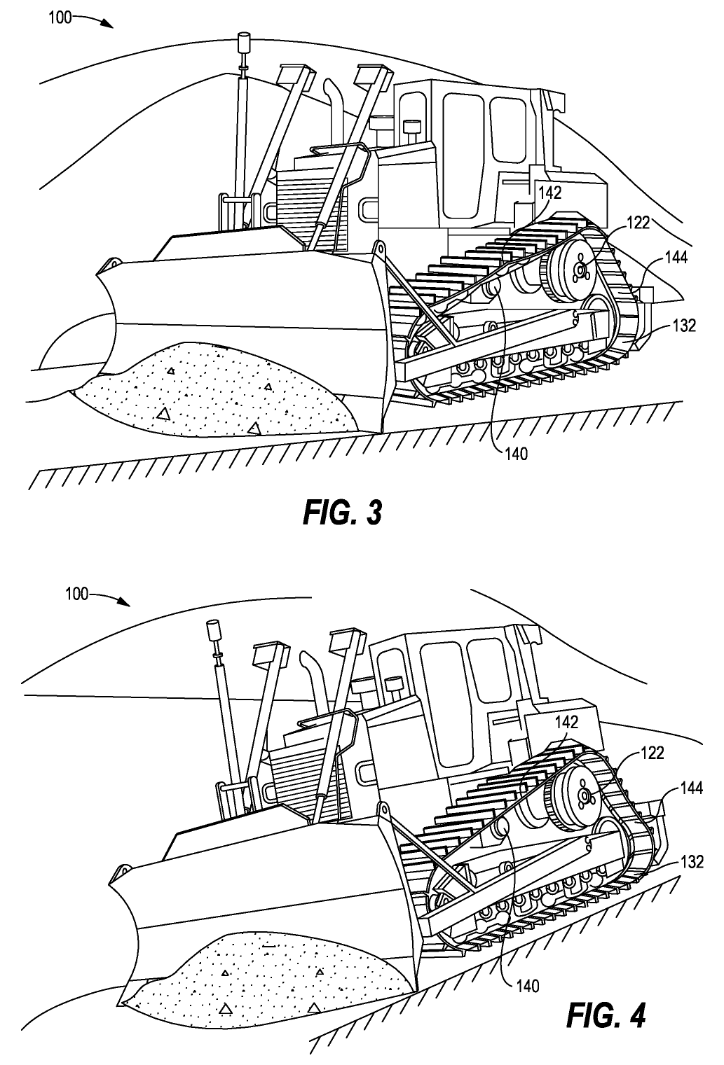

FIGS. 3 and 4 illustrate a condition where the work machine 100 has been in service for a long time, and tension in the track 132 has loosened over time. As shown in FIG. 3, when the work machine 100 is on a level surface, the track 132 experiences slack in a front portion 142. As shown in FIG. 4, when the work machine 100 is on a downward slope, the track 132 experiences slack in a rear portion 144. The slack in the track 132 can cause reduced undercarriage life, increased fuel consumption, and poor grading performance of the work machine 100, among other issues.

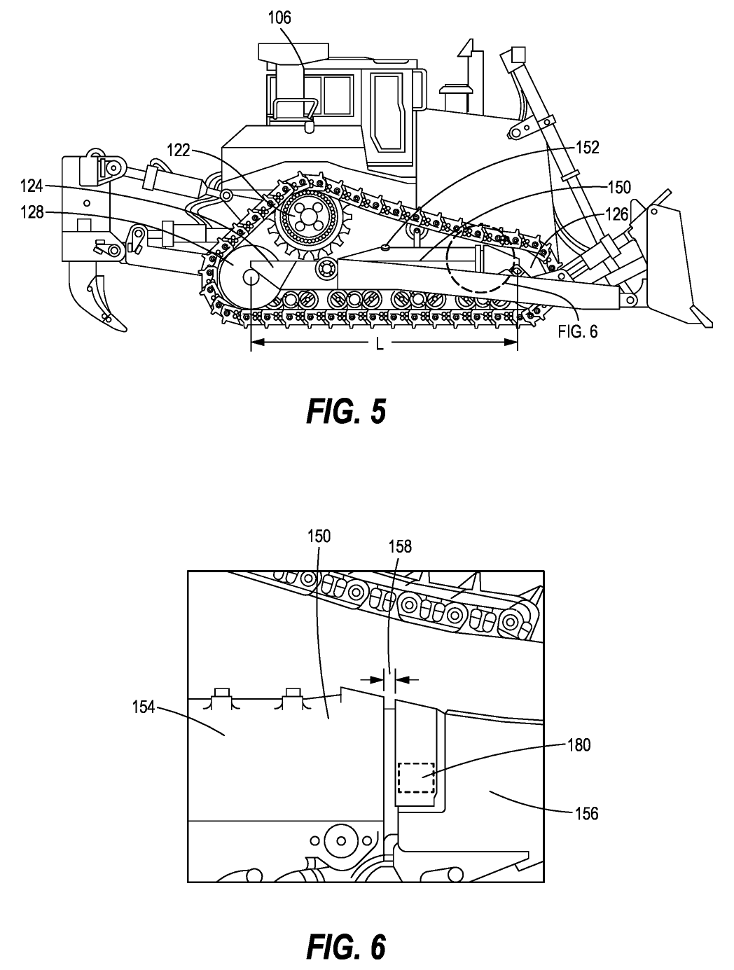

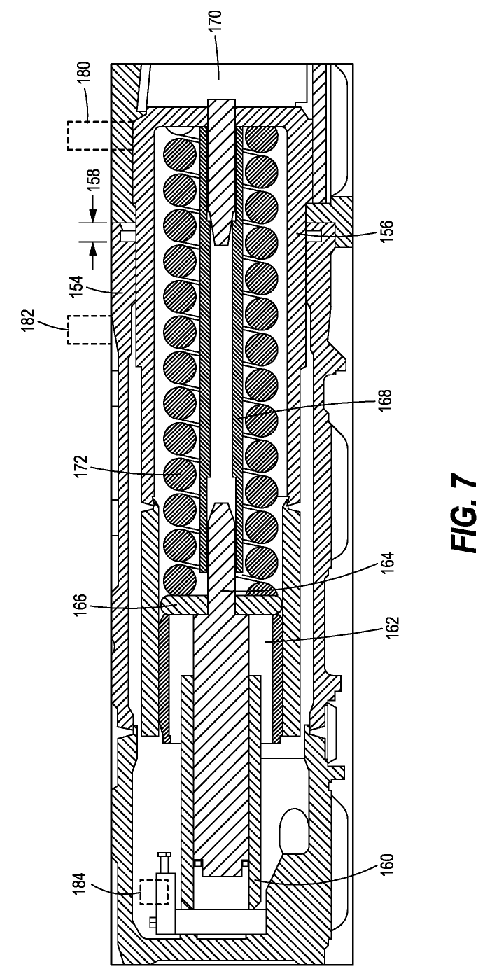

In order to prevent excess slack from building in the track 132, a track adjuster 150 may be mounted to the roller frame 124. The track adjuster 150 may also be integrated into the roller frame 124. As depicted in FIGS. 5-7 the roller frame 124 is split into a front track roller frame 156 connected to the front idler 126, and a rear track roller frame 154 connected to the rear idler 128. As shown in FIG. 7, a portion of the front track roller frame 156 may sit within the rear track roller frame 154. The track adjuster 150 may adjust the front track roller frame 156 relative to the rear track roller frame 154. In this manner, the front idler 126 may move relative to the roller frame 124 and the rear idler 128. FIG. 6 illustrates a gap 158 between the front track roller frame 156 and the rear track roller frame 154. In one embodiment, a first position sensor 180 may be provided on the front track roller frame 156 such that the gap can be measured directly or indirectly using the first position sensor 180 while the work machine 100 is in use. For example, the first position sensor 180 may measure the position of the piston 164.

FIG. 7 illustrates a cross-section view of the track adjuster 150. The track adjuster 150 may include a track adjust cylinder 160 disposed within the rear track roller frame 154. In order to bias the front idler 126 and thereby adjust tension in the track 132, an operator may manually adjust the track adjust cylinder 160 by opening a cover on the rear track roller frame 154 and reaching through an access opening 152 (FIG. 5). The track adjust cylinder 160 may comprise a manual adjustment. The track adjust cylinder 160 may also comprise a hydraulic cylinder, and the operator may adjust a pressure within the track adjust cylinder 160. A pressure sensor 184 may be connected to the track adjust cylinder 160 such that the pressure within may be monitored by the controller 110.

In order to move the front track roller frame 156, a piston 164 may be disposed within the track adjust cylinder 160. The piston 164 may be connected to a stop tube 168, which is connected to a cap 170 attached to the front track roller frame 156. The track adjuster 150 may include a recoil spring 172 in order to dampen vibrations on the track adjuster 150. The recoil spring 172 may be disposed between the front track roller frame 156 and a spring reaction plate 166 disposed about an end of the piston 164 proximate a retainer 162 disposed about the track adjust cylinder 160 and the piston 164. In order to accurately track displacement of the front track roller frame 156, a second position sensor 182 may be provided on the rear track roller frame 154 in addition to the first position sensor 180 on the front track roller frame 156.

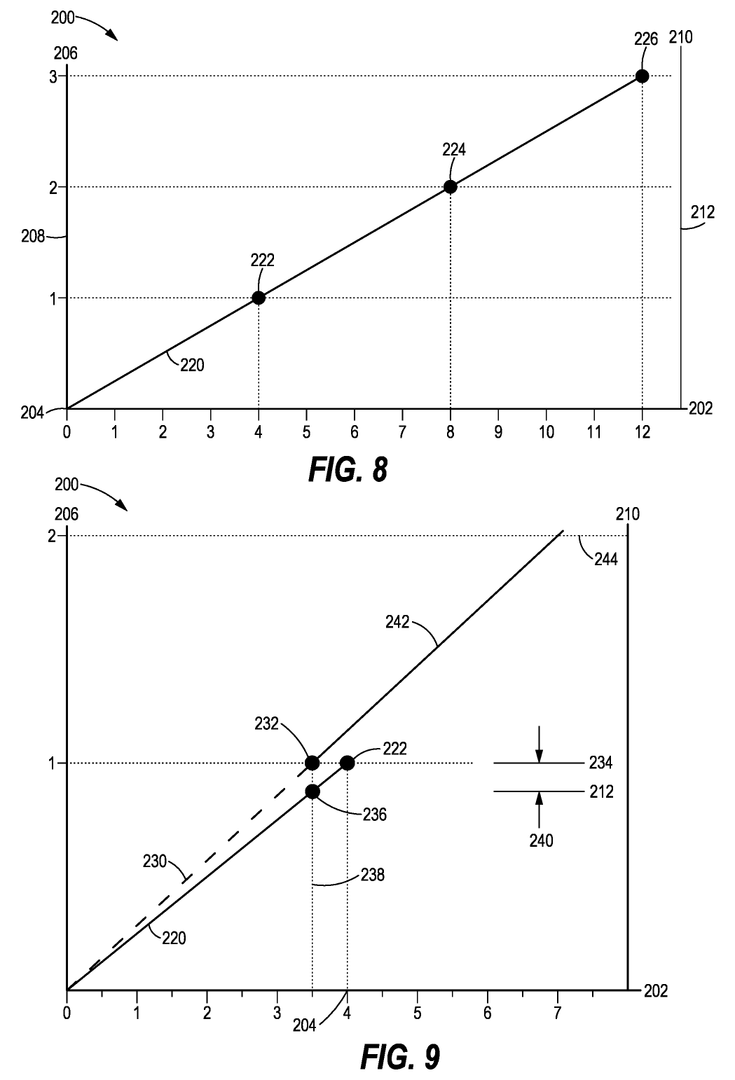

The controller 110 may include programming such that the work machine 100 contains a tension monitoring system 200. The controller 110 may monitor the distance that the work machine 100 has travelled such that an undercarriage wear or life used may be determined. The controller 110 may prompt the operator to service the track adjuster 150 at predicted predetermined intervals or when a wear interval is signaled by the wear sensor 138. The controller 110 may be programmed with a predicted wear rate 220, stored in a memory of the controller 110. FIG. 8 illustrates a graphical representation of the predicted wear rate 220 as a function of undercarriage life 202 and a front idler position axis 210. The undercarriage life 202 is shown in the graph of FIGS. 8-10. The undercarriage life 202 may be measured as a distance travelled as shown in FIGS. 8-10, but may also be measured as a life percentage estimate. The tension monitoring system 200 may prompt the operator or a supervisor to adjust the track adjuster 150. The wear interval generated by the wear sensor 138 may include a plurality of wear intervals 208 over the undercarriage life 202. As shown in FIG. 8, three wear intervals 208 may be used over the service life of the track 132, although, any number of wear intervals 208 may be used. For example, the plurality of wear intervals 208 may occur when the one of the plurality of links 134 detects 40% wear, 70% percent wear, and 100% wear from the wear sensor 138. Smaller service intervals may also be desired to monitor link wear more often. The work machine 100 may include two of the track-type drivetrain 120. The two of the track-type drivetrain 120 may be monitored together and/or separately, and may follow the same service interval schedule, or may follow different schedules. For example, one of the track-type drivetrain 120 may have the plurality of service intervals 208 occur at 20%, 55%, and 85% wear; and the other of the track-type drivetrain 120 may have the plurality of service intervals 208 occur at 40%, 70%, and 100% wear.

The first position sensor 180 and the second position sensor 182 may be connected to the controller 110 such that, when the controller 110 prompts the operator or the supervisor by an input from the wear sensor 138 that one of the plurality of wear intervals 208 is current, the controller evaluates the front idler position 212. As shown in FIG. 8, a predicted first wear signal 222 is given at first wear interval, a predicted second wear signal 224 is given at a second wear interval, and a predicted third wear signal 226 is given at a third wear interval.

FIG. 9 shows a graph illustrating operation of the tension monitoring system 200. The controller 110 responds to the predicted first wear signal 222 at a first wear interval. The controller 110 evaluates the front idler position 212 based on a predicted front idler position 234 based on the predicted wear rate 220. In the example of FIG. 9, the predicted first wear signal 222 is triggered as the predicted front idler position 234 has occurred before a predicted adjustment interval 204. The controller 110 registers this signal as an actual track link wear interval signal 232. The controller 110 evaluates an actual adjustment interval 238 against the predicted adjustment interval 204, and evaluates an idler position error 240 as a difference between the predicted front idler position 234 and an idler position 236 that is what was predicted at the actual adjustment interval 238 based on the predicted wear rate 220. The controller 110 can then calculate an actual wear rate 230 of the track 132 and extrapolate to calculate an adapted wear rate 242. The controller 110 can then rewrite the predicted wear rate 220 such that it is truncated at the actual adjustment interval 238 and conforms to the adapted wear rate 242. When the predicted second wear signal 224 occurs, the controller 110 can then evaluate the front idler position based on a second wear monitoring system indicator 244 based on the adapted wear rate 242.

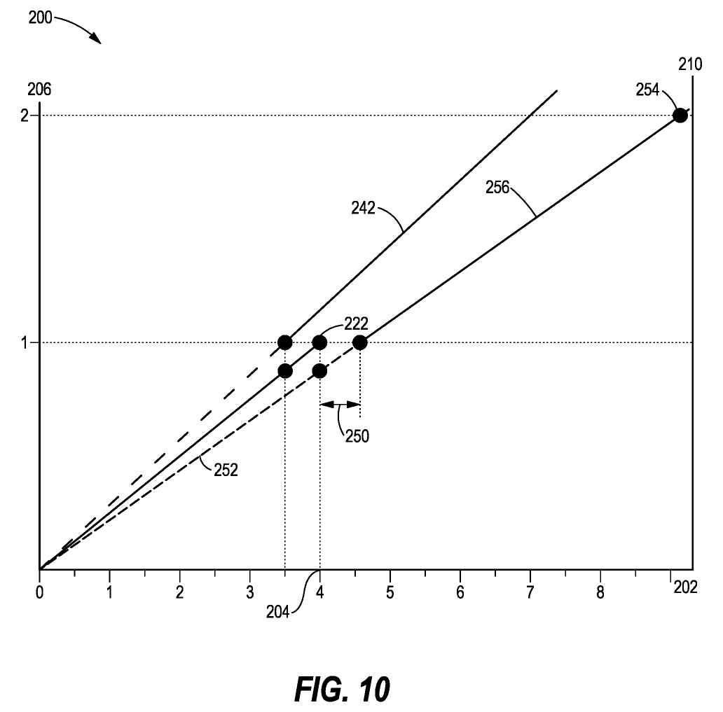

FIG. 10 is a chart that illustrates the opposite condition, where the predicted first wear signal 222 is present and the adjustment interval is greater than predicted. The controller 110 evaluates that an actual wear rate 252 is slower than the predicted wear rate 220, and rewrites the predicted wear rate 220 such that a second wear monitoring system indicator 254 follows an adapted wear rate 256 based on the actual wear rate 252.

### INDUSTRIAL APPLICABILITY

In operation, the teachings of the present disclosure can find applicability in many industries including but not limited to work machines used in the earth moving, mining, agricultural, and construction industries. While depicted and described in conjunction with a track-type tractor , such teachings can also find applicability with other machines such as on and off highway trucks, excavators, loaders, mining vehicles, and other types of machines known to persons skilled in the art.

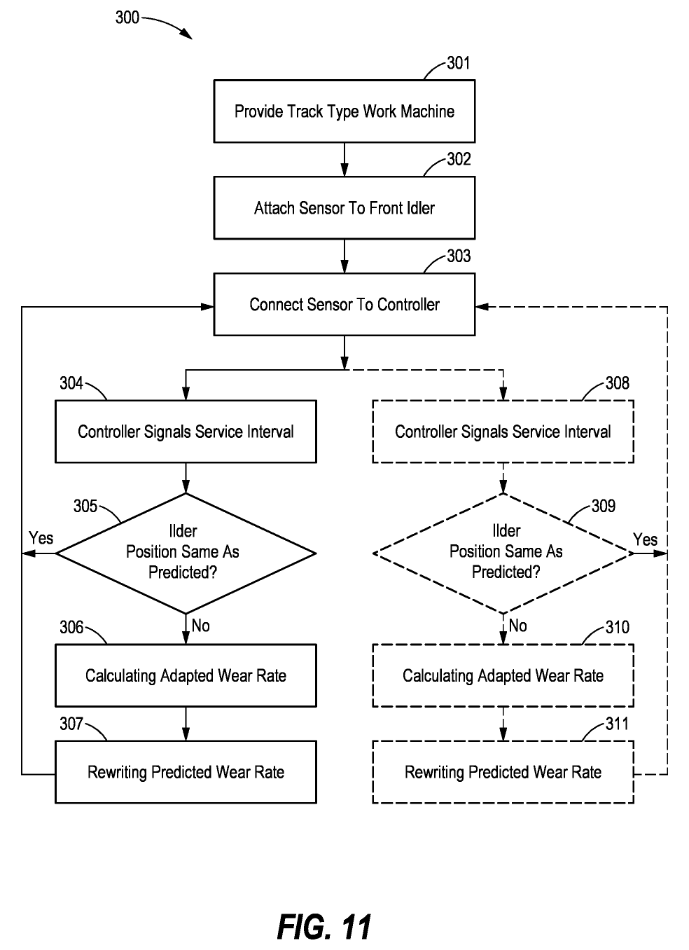

FIG. 11 illustrates a visual representation of a method 300 of monitoring track tension of the work machine 100. In a first step 301, the track-type drivetrain 120 is provided attached to the frame 102 of the work machine 100. Providing the track-type drivetrain 120 includes providing the roller frame 124, the sprocket 122, the rear idler 128, the front idler 126 , the roller 130, and the track 132. The roller frame 124 also includes the track adjuster 150. The roller frame 124 includes the front track roller frame 156 separate from the rear track roller frame 154, the track adjuster 150 spacing the front idler 126 relative to the rear idler 128 through this separation, thereby adjusting tension in the track 132.

In a second step, 302, the first position sensor 180 is attached to the front track roller frame 156 or the rear track roller frame 154 such that the first position sensor 180 determines the front idler position 212 by directly or indirectly measuring the gap 158. The second position sensor 182 may be attached to the rear track roller frame 154, and may measure extension of the piston 164 from the cylinder 160. The first position sensor 180 and the second position sensor 182 may be adapted to work in tandem, and may be used for further system diagnostics. The pressure sensor 184 may also be attached to the track adjuster 150 if a hydraulic cylinder is utilized. In a third step 303, the sensors may be connected to the controller 110.

The controller 110 may be programmed with the predicted wear rate 220, configured to prompt the operator of service adjustment intervals and wear intervals. In a fourth step 304, the controller 110 receives a signal from the wear sensor 138 of the plurality of links 134 and prompts a service interval signal.

In a fifth step 305, the controller 110 uses the sensors to measure the idler position 236 and determines if the idler position 236 is different from the predicted idler position at the predicted first wear signal 222. If the positions are the same, the controller 110 continues to monitor using the predicted wear rate 220 until a subsequent service interval. If the positions are not the same, in a sixth step 306, the controller 110 calculates the adapted wear rate (242, 256) based on the actual wear rate (230, 242), calculates the actual adjustment interval 238, and, in a seventh step 307, rewrites the predicted wear rate 220 to follow the adapted wear rate (242, 256). The controller 110 may also provide a corrected idler position prompt to the operator for that service interval.

Eighth step 308, ninth step 309, tenth step 310, and eleventh step 311 mirror the fourth step 304 through the seventh step 307 in the embodiment wherein a first of the track-type drivetrain 120 and a second of the track-type drivetrain 120 follow different service intervals. Eighth step 308 indicates that the track-type drivetrain 120 on a right side of the work machine 100 is following a different service interval than the left side of the work machine 100.

The method 300 of monitoring track tension of the work machine 100 describes operation of the work machine 100 of the primary embodiment, and how in operation, the work machine 100 may evaluate tension of the track 132. The method 300 allows for the work machine 100 to effectively predict track tension over the service life of the track 132. While service personnel would still be required to adjust track tension via the track adjuster 150, monitoring, as specified in the method 300, would negate the need for additional service tests of the track 132 of the work machine 100, allowing for reduced downtime.

The method 300 can be adapted to any work machine 100, requiring only sensor installation and a software update to retrofit. The method 300 can also be adapted to other industries and any machine utilizing the track-type drivetrain 120 to propel the machine.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A work machine, comprising:
a frame;
an implement supported by the frame;
a track-type drivetrain attached to the frame and configured to support the frame and provide motive power to the work machine, the track-type drivetrain including a roller frame, a sprocket, a rear idler, a front idler, a roller, and a track;
a track adjuster mounted on the roller frame and configured such that the front idler is adjustable on the roller frame relative to the rear idler to adjust a track tension of the track;
a sensor associated with at least one of the front idler or the track adjuster; and
a controller configured to:
obtain, via the sensor, position information of the front idler relative to the rear idler that is different from calibration position information;
determine, based on the position information and the calibration position information, a change in the track tension from a first track tension, that corresponds to the calibration position information, to a second track tension that corresponds to the position information; and
cause, based on the change in the track tension, adjustment of the front idler, via the track adjuster, to restore the track tension to the first track tension.

2. The work machine of claim 1, wherein the roller frame of the track-type drivetrain comprises a front track roller frame connected to the front idler, and a rear track roller frame connected to the rear idler, the track adjuster configured such that the front track roller frame and the rear track roller frame are movable relative to one another.

3. The work machine of claim 2, wherein the sensor further comprises a first position sensor mounted to the front track roller frame and a second position sensor mounted to the rear track roller frame, and wherein to obtain the position information the controller is further configured to obtain a distance between the first position sensor and the second position sensor and determine, based on the distance, a position of the front idler relative to the rear idler.

4. The work machine of claim 2, wherein the track adjuster is a mechanical cylinder that comprises:
a track adjust cylinder disposed within the rear track roller frame;
a piston disposed within the track adjust cylinder;
a retainer disposed about the track adjust cylinder and the piston;
a spring reaction plate disposed about an end of the piston proximate the retainer;
a stop tube connecting the piston to the front track roller frame; and
a recoil spring disposed between the front track roller frame and the spring reaction plate.

5. The work machine of claim 4, wherein the rear track roller frame further comprises an access opening for adjusting the track adjust cylinder, the access opening having a removable cover.

6. The work machine of claim 2, wherein the track adjuster comprises a hydraulic cylinder.

7. The work machine of claim 6, wherein the sensor comprises a pressure sensor to monitor a pressure within the hydraulic cylinder.

8. A tension monitoring system for a track-type machine, comprising:
a track adjuster configured to be coupled to a front idler and a rear idler of a roller frame of a track-type drivetrain, and to move the front idler relative to the rear idler;
a sensor associated with at least one of the roller frame or the track adjuster and configured to indicate a position of the front idler relative to the rear idler; and
a controller connected to the sensor and configured to:
obtain, at a first service interval that is based on a first predicted wear rate associated with a track of the track-type machine, a first position of the front idler, wherein the first service interval defines a first timing for adjustment of a track tension of the track;
determine, based on a difference between the first position and a first predicted position of the front idler at the first service interval:
a second wear rate that is different from a predicted second wear rate; and
a second service interval, based on the second wear rate, that is different from a predicted second service interval; and
set, based on the second service interval, a second timing for adjustment of the track tension.

9. The tension monitoring system of claim 8, wherein the roller frame of the track adjuster further comprises a front track roller frame connected to the front idler, and a rear track roller frame connected to the rear idler, movable relative to the front track roller frame.

10. The tension monitoring system of claim 9, wherein the sensor further comprises a first position sensor mounted to the front track roller frame and a second position sensor mounted to the rear track roller frame, the controller calculating first predicted position of the front idler as a distance between the first position sensor and the second position sensor.

11. The tension monitoring system of claim 10, the track adjuster comprising a mechanical cylinder for adjusting the front idler, and further comprising:
a track adjust cylinder disposed within the rear track roller frame;
a piston disposed within the track adjust cylinder;
a retainer disposed about the track adjust cylinder and the piston;
a spring reaction plate disposed about an end of the piston proximate the retainer;
a stop tube connecting the piston to the front track roller frame; and
a recoil spring disposed between the front track roller frame and the spring reaction plate.

12. The tension monitoring system of claim 11, wherein the rear track roller frame further comprises an access opening for allowing a worker to reach within a housing of the rear track roller frame and adjust the track adjust cylinder, the access opening having a removable cover.

13. The tension monitoring system of claim 10, wherein the track adjuster further comprises a hydraulic cylinder biasing the front idler in a forward direction.

14. The tension monitoring system of claim 13, wherein the sensor further comprises a pressure sensor connected to the hydraulic cylinder to monitor a pressure within the hydraulic cylinder.

15. A method of monitoring track tension of a track-type work machine, comprising:
providing a track-type drivetrain attached to a frame of a work machine, including a roller frame, a sprocket, a rear idler, a front idler, a roller, and a track, the roller frame including a track adjuster configured to space the front idler relative to the rear idler, thereby adjusting tension in the track;
attaching a sensor to the front idler configured to measure a front idler position;
connecting the sensor to a controller;
programming a predicted wear rate on the controller, the predicted wear rate configured to provide a predicted idler position at a service interval of the track-type work machine based on an undercarriage life measurement;
measuring the front idler position via the sensor, at the service interval;
determining that the front idler position is different from the predicted idler position, the controller then calculating an adapted wear rate, calculating an adjustment interval, and rewriting the predicted wear rate based on the adjustment interval.

16. The method of claim 15, wherein programming the controller further comprises calculating the service interval based on a wear indicator of the track-type work machine.

17. The method of claim 16, further comprising calculating the wear indicator based on a life percentage estimate of a track link wear sensor of the track.

18. The method of claim 17, further comprising the service interval comprising a plurality of service intervals at a plurality of life percentage estimates.

19. The method of claim 18, wherein the plurality of service intervals further comprises an interval at 0%, 40%, 70%, and 100% of service life of the track.

20. The method of claim 18, wherein the step of providing the track-type drivetrain, further comprises a left track and a right track, the left track and the right track each having service intervals at different life percentage estimates.
